(19) United States
(12) Patent Application Publication
(10) Pub. No.: US 2016/0092800 A1
(43) Pub. Date: Mar. 31, 2016

(54) VOLUME IDENTIFICATION SYSTEM

(71) Applicant: HEAD LOGÍSTICA ARMAZENAGEM E TRANSPORTE LTDA, Louveira (BR)

(72) Inventor: Rodolpho Marcus BORGES PICOLO, Jundiai - SP (BR)

(73) Assignee: HEAD LOGÍSTICA ARMAZENAGEM E TRANSPORTE LTDA, Louveira (BR)

(21) Appl. No.: 14/501,913

(22) Filed: Sep. 30, 2014

(51) Int. Cl. G06Q 10/06; G06Q 10/08

(52) U.S. Cl. CPC G06Q 10/0631; G06Q 10/0837

(57) ABSTRACT

“VOLUME IDENTIFICATION SYSTEM”, which has its application in the field of logistics of products collection and its shipment to the final recipients. The present patent application aims to provide a volume identification system useful in logistical procedures involved in the collection of miscellaneous and its shipment to the manufacturer or representative, as well as the return of such products to its point of origin, a software that allows the necessary control of the volume identification throughout its course being used.

This specification relates to an invention patent comprising a volume identification system, which has its application in the logistic field of products collection and its shipment to the final recipients.

The present patent application aims to provide a volume identification system useful in logistical procedures involved in the collection of miscellaneous products and its shipment to the manufacturer or representative, as well as the return of such products to its point of origin.

The current state of the art contemplates certain situations, where a manufacturer or its representative needs to receive, in return, one or more products of its products line, being that such return comes from the users or end consumers. Later that same manufacturer or its representative must proceed to the reshipment, to the user or end consumer, of equivalent product in replacement or substitution of the collected item.

Currently this type of processing is done in the conventional way, through means of controls based on manual records, a fact that implies low efficiency, possibility of several errors and demand of greater time to complete all the phases of the procedure.

Inside the framework contemplated by the state of the art, the volume identification system provided by this invention patent application was developed, which has as object to enable the products identification and collection used by clients from clients inside a product supply network to enable such products to be dispatched in other logistic operators defined by the client itself to be delivered to the final recipients.

The object system of this invention patent application will be detailed and described with reference to the figures below, in which:

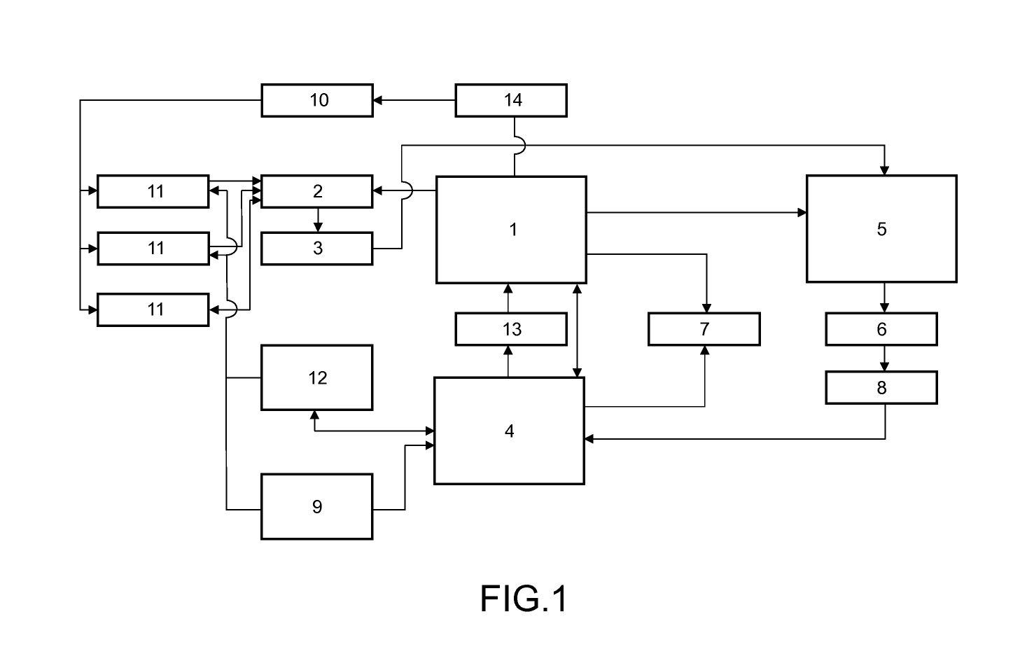

FIG. 1 illustrates a general flowchart of the system here applied;

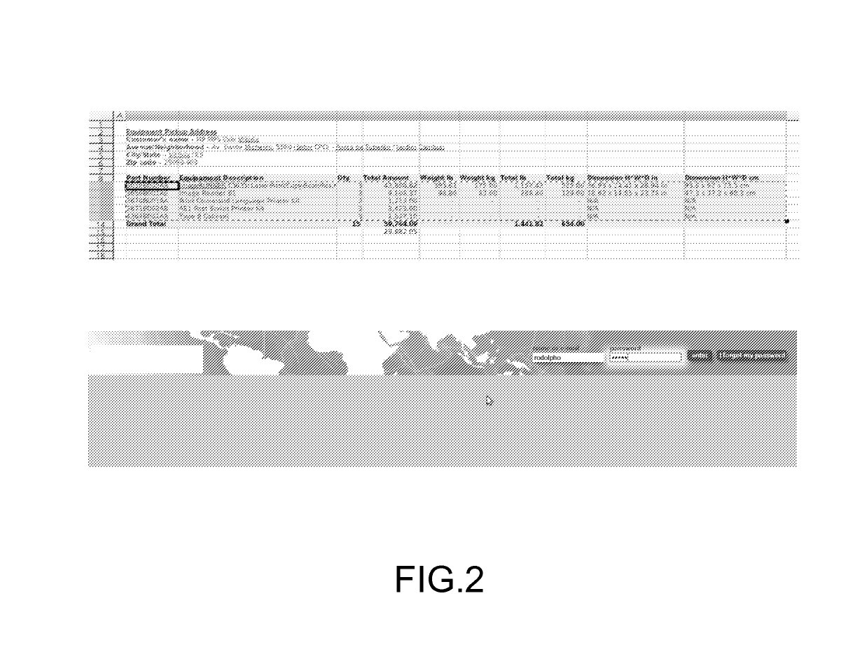

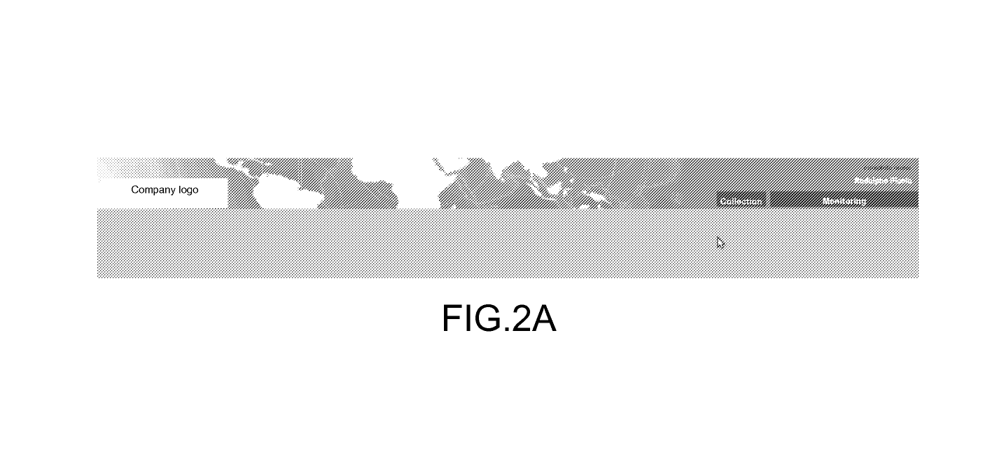

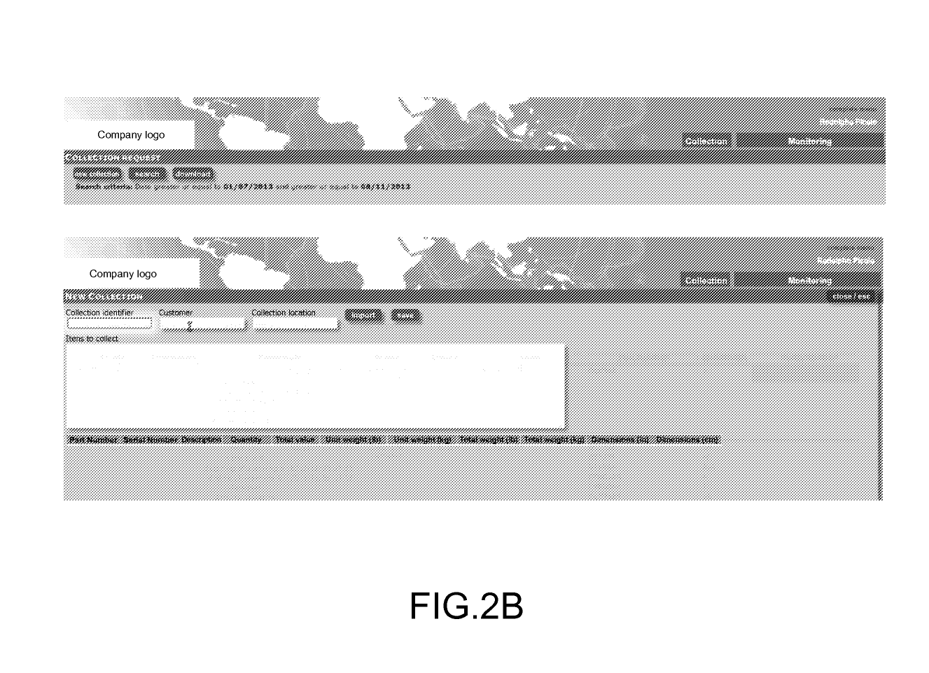

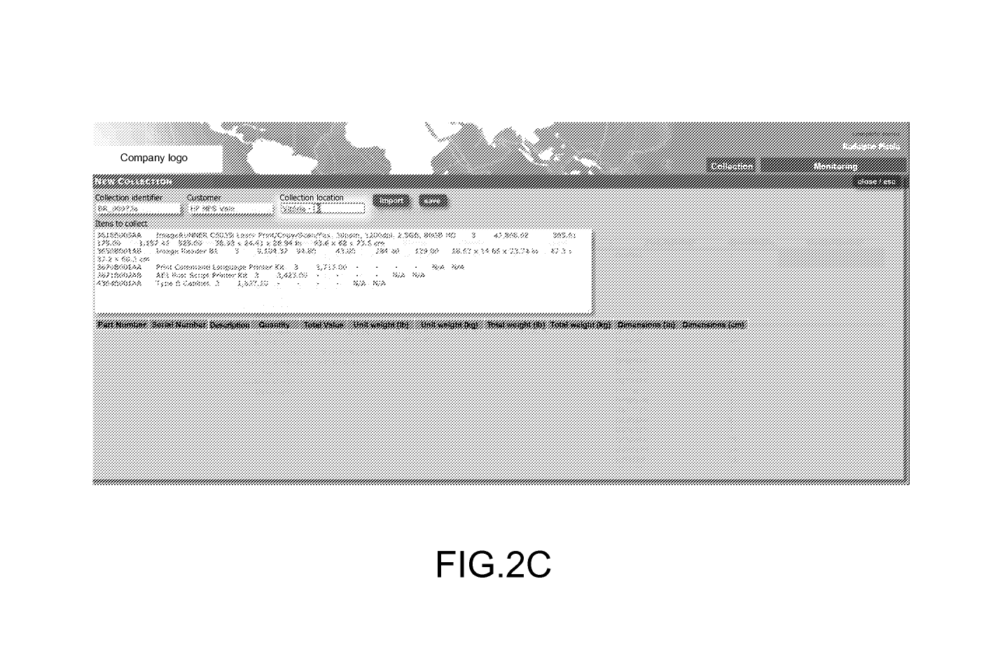

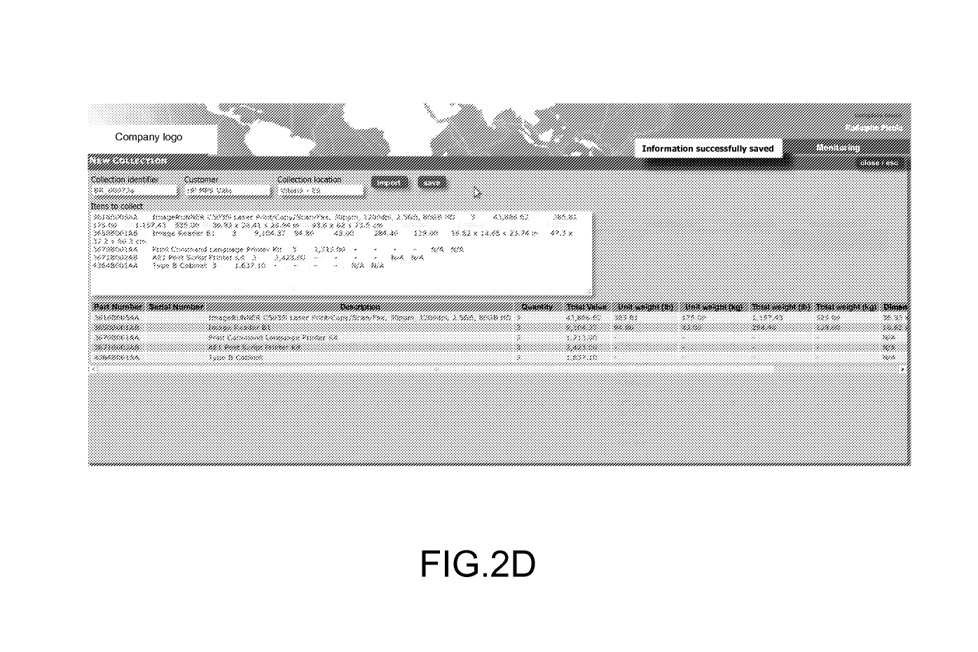

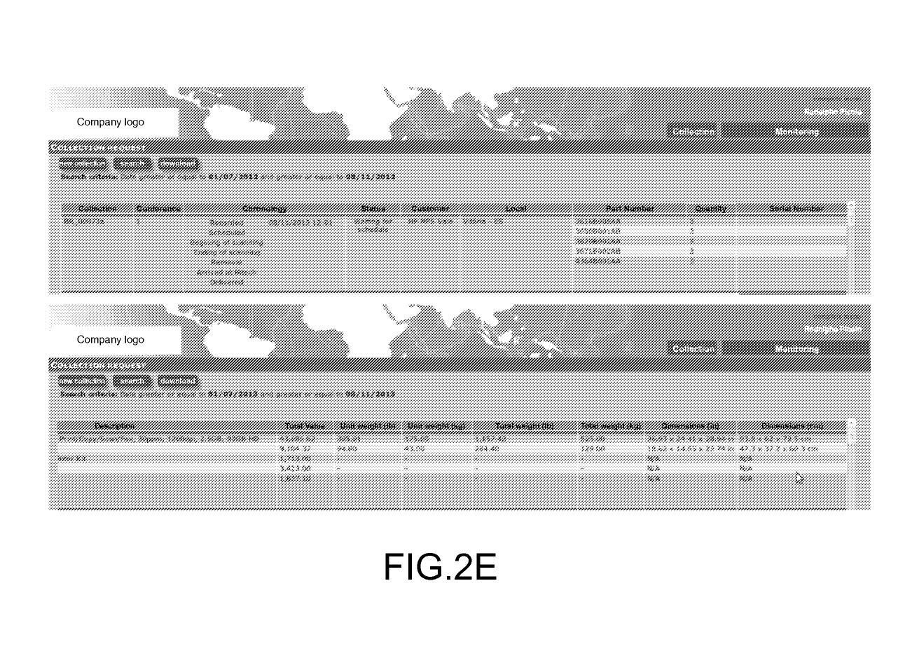

FIGS. 2, 2A, 2B, 2C, 2D and 2E illustrate program screen images used in the present system regarding to the collection Request phase;

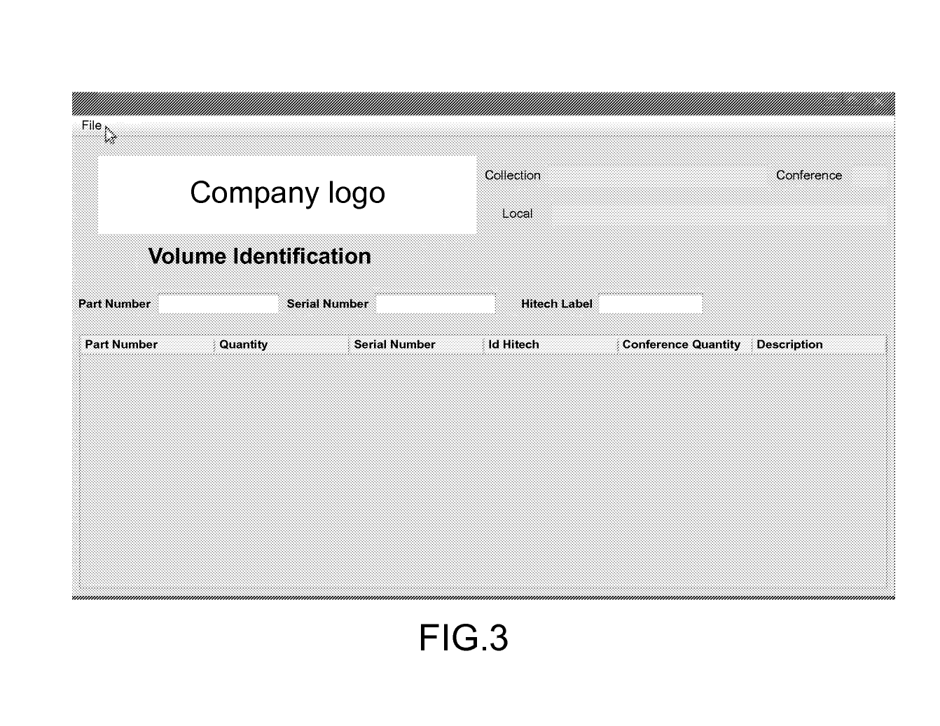

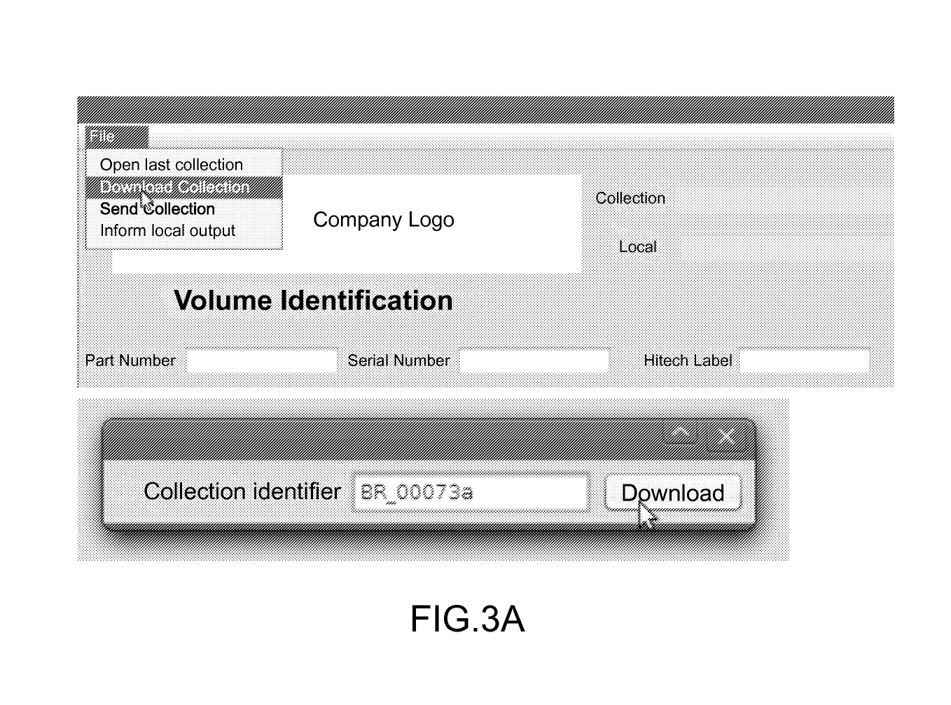

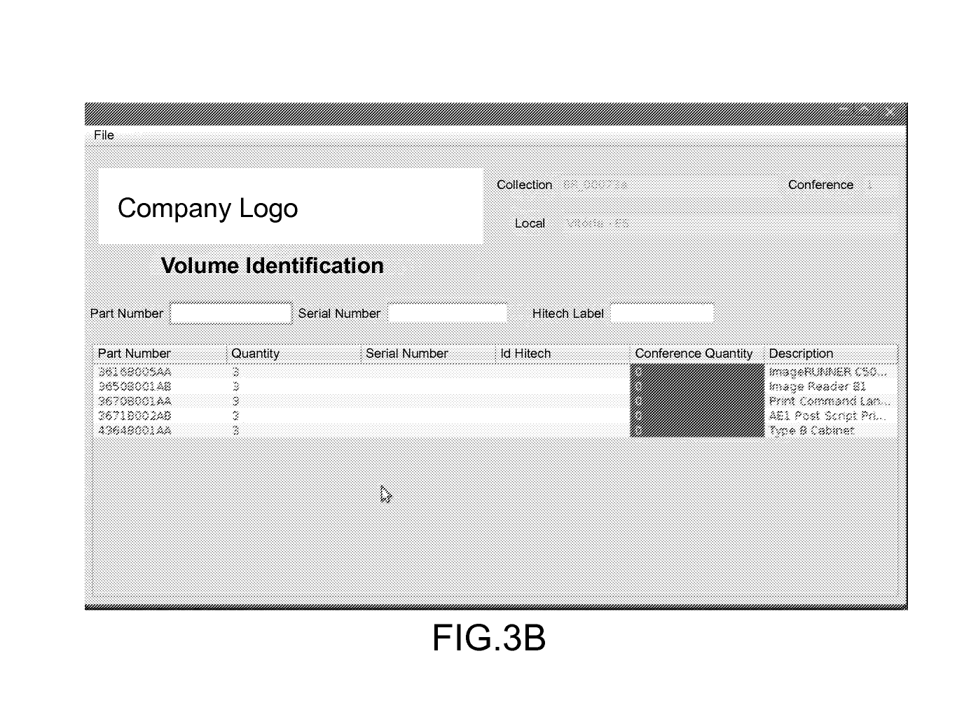

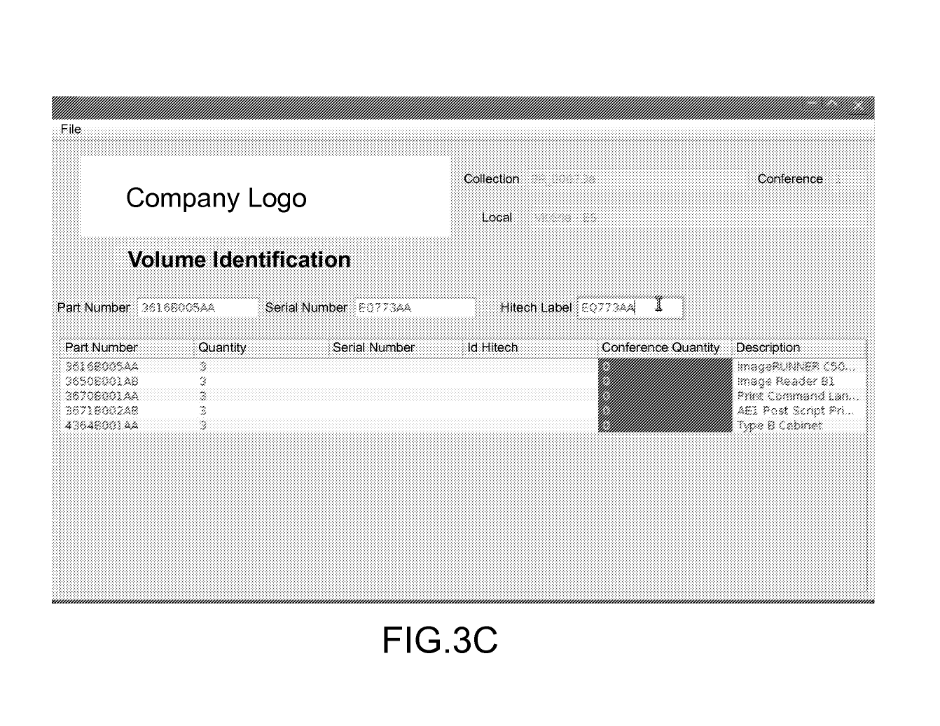

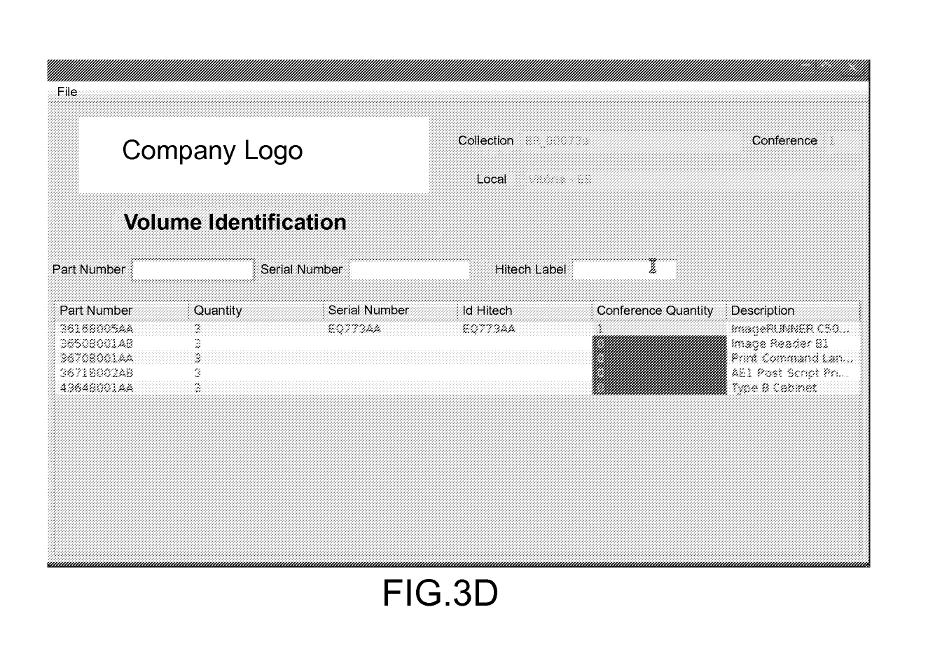

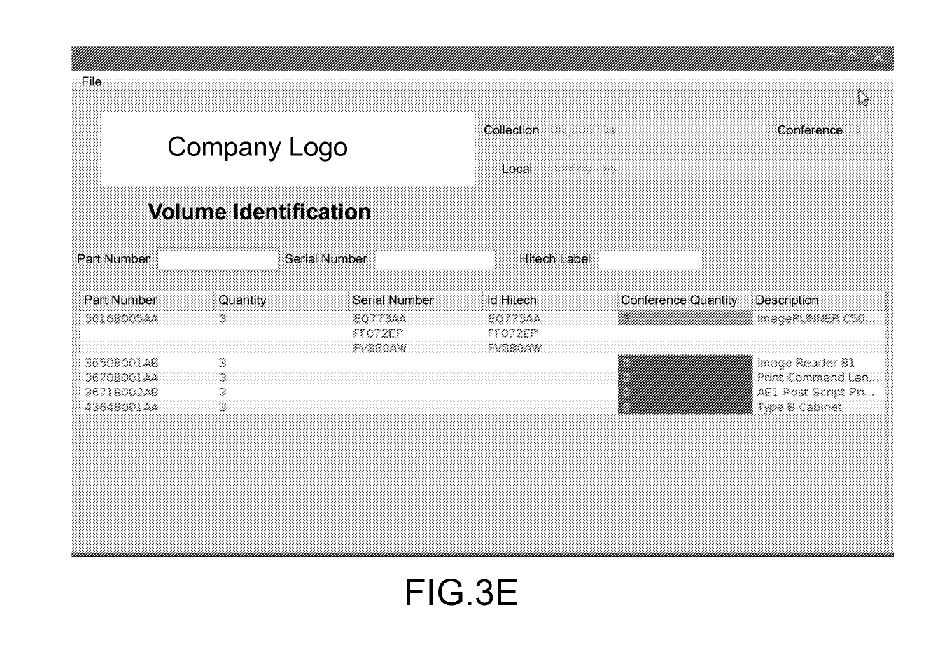

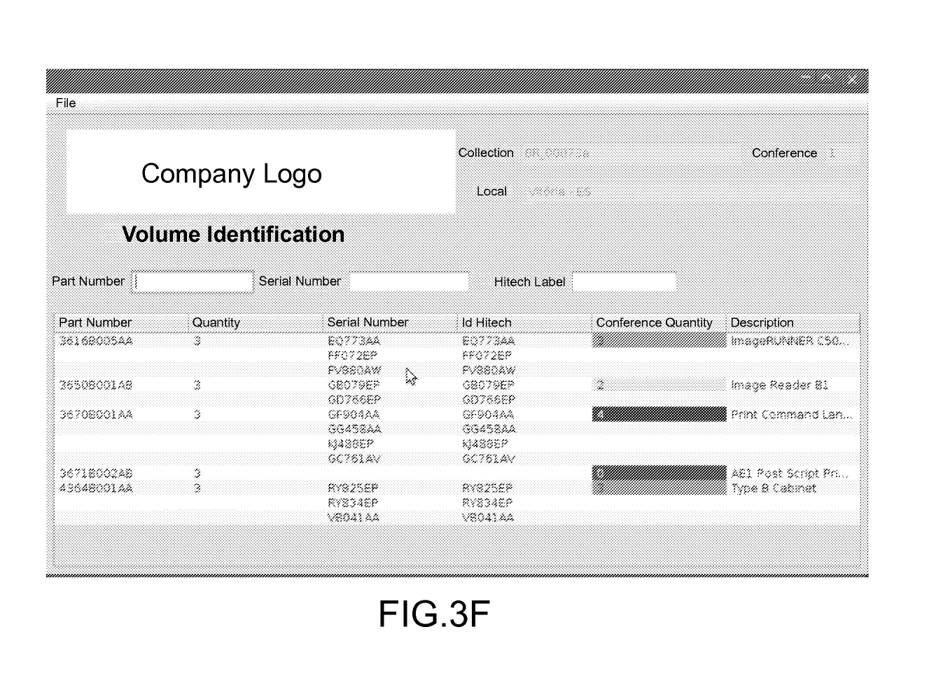

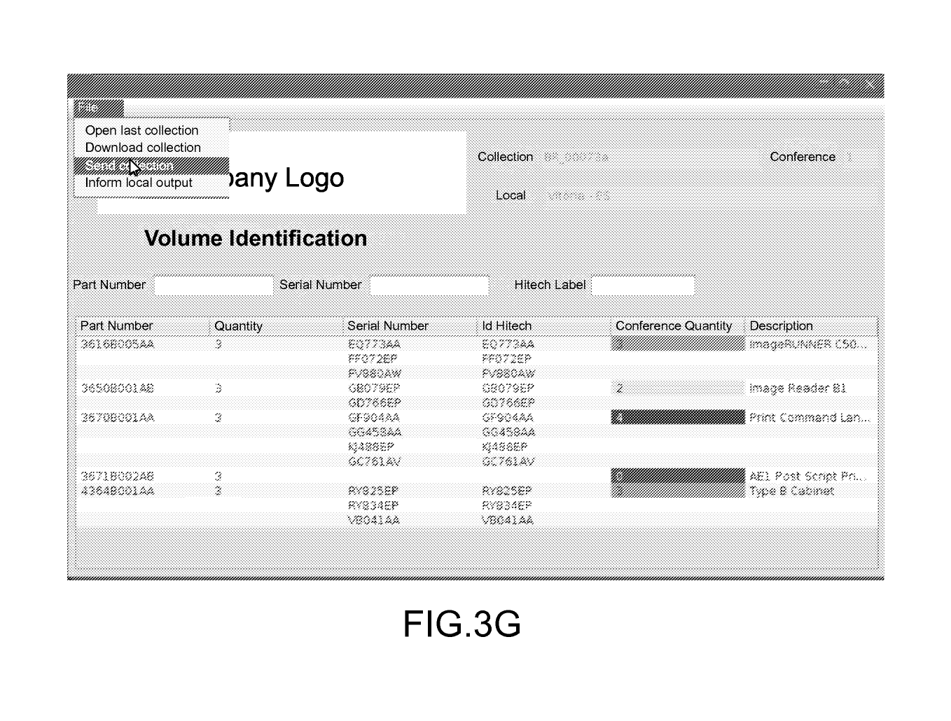

FIG. 3, 3A, 3B, 3C, 3D, 3E, 3F, 3G illustrate other program screen images used in the present system regarding to the product Identification phase at the dispatch point;

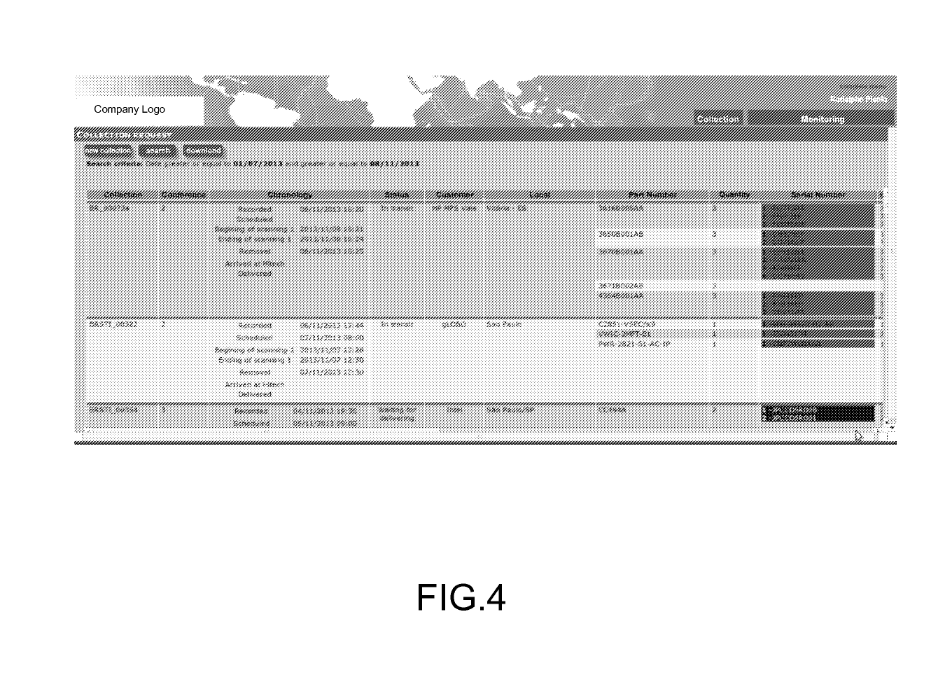

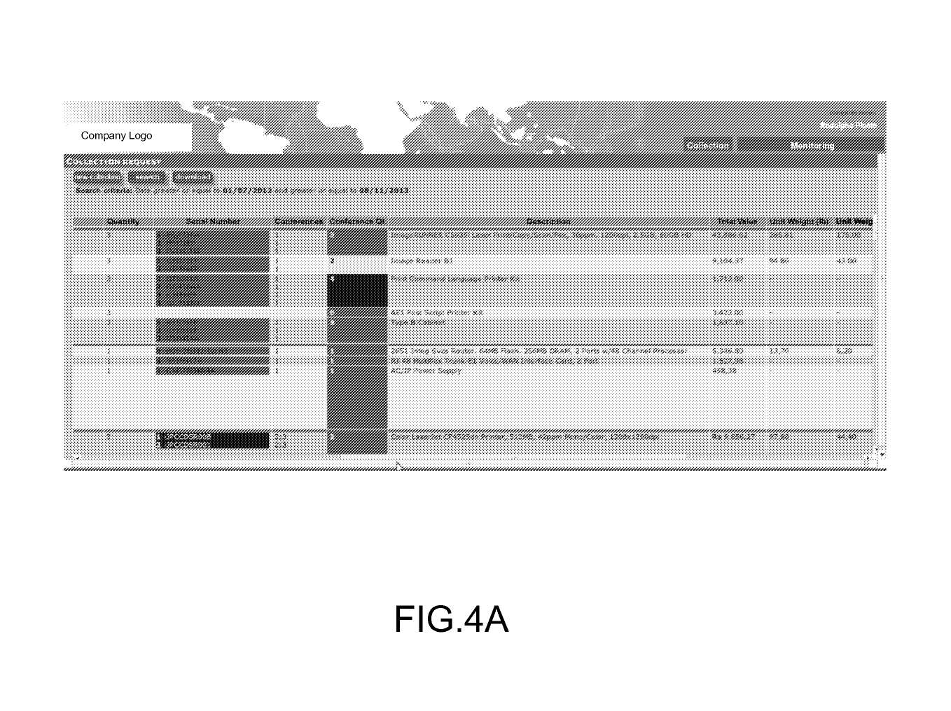

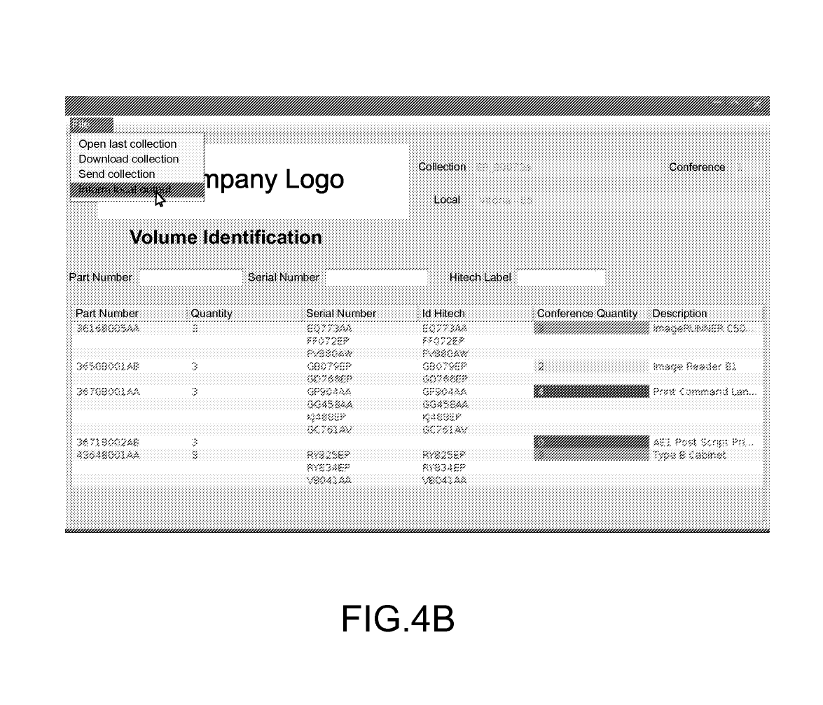

FIGS. 4, 4A and 4B illustrate other program screen images used in the present system regarding to the load Validation phase; and

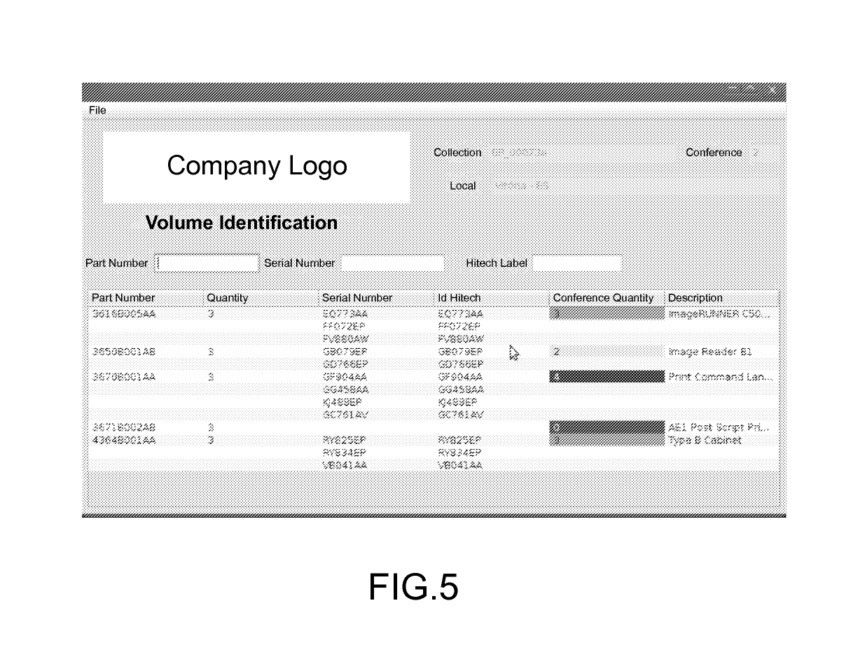

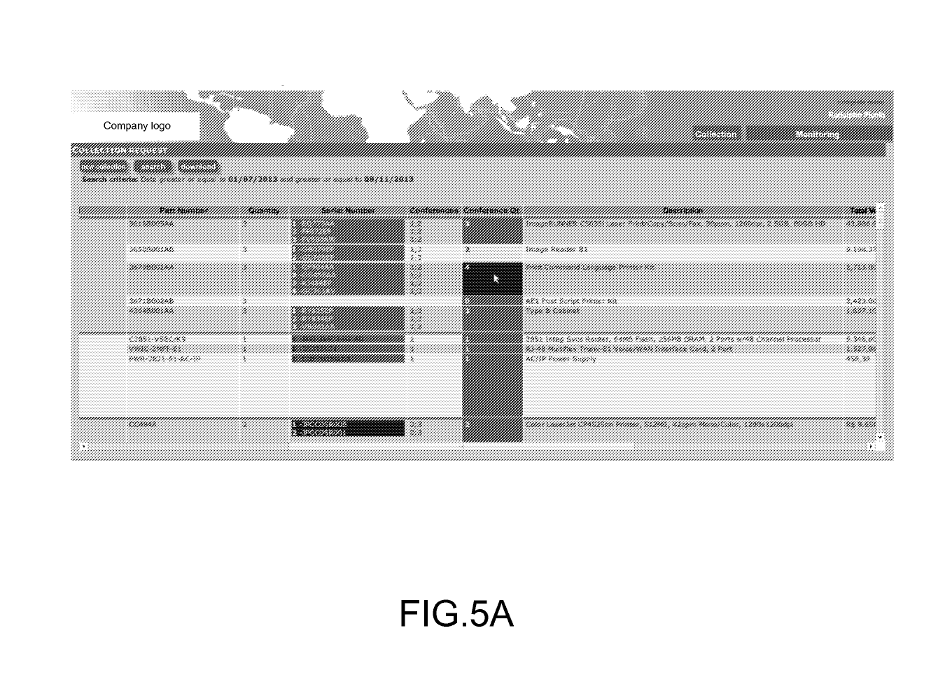

FIGS. 5 and 5A illustrate two more program screen images used in the present system regarding to the load Re-identification phase.

In accordance with how much the figures listed above illustrate, the volume identification system, object of this invention patent application, comprises a process flow that foreseen the following phases:
a) Collection request;
b) Product identification at the dispatch point;
c) Load validation;
d) Return to the central base;
e) Load re-identification;
f) Re-dispatch definition; and
g) Re-dispatch.

Regarding the Collection request phase, this step is combined between the central base 1 and a client 2 on the basis of the supposed volume load, collection site and shipper availability, the collection date, etc.

Client 2 sends a spreadsheet 3 detailing all items that will be collected, as the example that can be understood by observing FIG. 2, which is a program screen image regarding to the spreadsheet 3 that is used (accessed) by the central base team 1.

FIGS. 2A, 2B, and 2C illustrate the operations in which: the access to the collections is done through the option “collections” (operation depicted in FIG. 2A); it is selected the “button” “new collection” so to promote the registration of the spreadsheet information 3 (operation described in FIG. 2B); and to promote the copy of the spreadsheet information that are “collected” in the system page (operation depicted in FIG. 2C).

FIG. 2D describes the program screen image where the operation regarding to the act occurs by using the “button” “import”, information are interpreted and later saved by using the “button” “save”.

FIG. 2E presents the program screen image regarding to the operation in which the result for monitoring is available in the home screen with the result of the registered collections.

The products identification phase at the dispatch point can be understood by observing FIG. 3, 3A, that illustrate the program screen images regarding to the phase wherein the field team 4 accesses the volume identification software integrated to the web environment 5 (operation described in FIG. 3), being that with the access to the Internet is performed the “download” 6 of the registered information in the previous step (operation depicted in FIGS. 3A and 3B).

The field team 4 identifies each load volume with the bars code reading corresponding to the “Part number”, “Serial Number” and “Label” that can be linked to each volume. The values related to this operation are inserted, respectively, in the display fields “Part Number”, “Serial Number” and “Label”, such as it is depicted in the program screen image described in FIG. 3C.

As the load volumes 7 are identified, the “status” of each one changes and it is viewed on the basis of the column color “Amount checked” (Amount checked), besides of linking the “Serial Number” and the label code to the respective “Part Number”, as it can be understood by observing FIGS. 3D and 3E.

At the end of the identification, it is possible to check, through the column colors “Amount Checked” (Amount checked), the volumes that had the amount identified equal to the requested in the “green” color, amount lower than the requested in the “yellow” color, amount upper than the requested in the “gray” color and no item identified in the “red” color, as it is depicted in FIG. 3F, where examples of these four conditions are presented.

The field team 4 sends the collection information 8 to the web environment 5, providing the information to all that have access to the system, as it is depicted in the FIG. 3G.

The load validation phase can be appreciated in FIGS. 4, 4A and 4B, being that in this phase, the central base team 1, through the present system and with the client representative 2, validate the items identified and make decisions aiming to correct the load, as well as to wait for a missing item or devolution to the shipper of an item that is not in the items to be collected.

After the validation, the field team 4 informs the collection site departure, that automatically increments the collection conferences accountant, being such accountant represented by the number of the process of volume identification to which the collection is submitted to, when registered, the references accountant is “1”, therefore all identification will be regarding to the reference “1”, if the accountant is incremented and a new identification is performed, this identification will be regarding to the current conference accountant.

At the return to the central base phase, the field team 4 returns to the central base 1 with all load volume 7 collected.

At the load re-identification phase, a central base team 1 repeats the operation of load validation identified as in the item 9 of FIG. 1, noting the arrival of all volume identified in the shipper, worth mentioning that in the field “conference”, at this process phase has value “2”, while in the load validation phase it had value “1”.

If a new search is performed in the interface web 5, there will be a difference in the column color “Part Number”, that at the Load validation phase was in “red” and now is in “green”, because at the load validation phase, the current conference was already “2”, leaving in “red” as a warning, indicating that there were pending matters regarding to the current conference, as it can be understood by viewing FIG. 5A.

In the re-dispatch definition phase the central base 1, client 2 and logistic operator 10 define the dispatch date.

Regarding to the re-dispatch phase, in the central base 1, the load volumes are carried up to the logistic operator 10 that will perform the re-dispatch to the respective clients from client 11.

In the present system the topic “software” can be divided in two, i.e., a) the interface web identified by the numerical reference 5 and the software “stand alone” of the field team 4.

The Software “stand alone” used by the field team runs in the “off-line” mode, but in certain times it needs to be connected to the Internet, because it communicates with third party software to save and acquire information.

The numerical references above described are represented schematically in FIG. 1, representing a basic diagram of the present system, where blocks are still depicted related to the products identification and collection operation 12 performed by the field team 4, the products shipment (block 13a, by the field team 4, to the central base 1; and the dispatch phase (block 14) of the central base 1 products for the logistic operator 10.

1. “VOLUME IDENTIFICATION SYSTEM”, wherein it is used to allow the products volumes identification, comprising a process flow foreseeing the following phases: a) Collection request; b) Product identification at the dispatch point; c) Load validation; d) Return to the central base; e) Load re-identification; f) Re-dispatch definition; and g) Re-dispatch, being that regarding to the collection request phase, this step is combined between a central base (1) and a client (2) on the basis of the supposed volume load, collection site, shipper availability, collection date, among others; being that in such phase the client (2) sends through the web environment (5) and against the use of a dedicated software to this purpose, a spreadsheet (3) detailing all items that will be collected; being that in this software the spreadsheet information remains registered (3), being that such information is available in the home screen with the result of the registered collections.

2. “VOLUME IDENTIFICATION SYSTEM” according to claim 1, wherein the products identification phase at the dispatch point foresees that the field team (4) access the software of volumes identification integrated to the web environment (5), being that with the access to the Internet it the download (6) of the registered information is performed; the field team (4) identifies each load volume (7); as the load volumes (7) are identified, the “status” of each one is altered and visualized on the basis of the column color “Amount checked” (Amount checked), besides linking the “Serial Number” and the label code to the respective “Part Number”; the field team (4) sends the collection information (8) to the web environment (5), providing information to all that have access to the system.

3. “VOLUME IDENTIFICATION SYSTEM” according to claim 1, wherein the load validation phase foresees that the central base team (1), through the present system and with the client representative, validate the items identified e make decisions that aim to correct the load, as to wait for a missing item or devolution to the shipper of an item that is not in the items to be collected; after the validation, the field team (4) informs the collection site departure, that automatically increments the collection conferences accountant, being such accountant represented by the number of process of volumes identification to which the collection is submitted to, when registered, the references counted is “1”, therefore all identification will be regarding to the reference “1”, if the accountant is incremented and a new identification is performed, this identification will be regarding to the current conference accountant.

4. “VOLUME IDENTIFICATION SYSTEM” according to claim 1, wherein at the return to the central base phase, the field team (4) returns to the central base (1) with all load volumes (7) collected.

5. “VOLUME IDENTIFICATION SYSTEM” according to claim 1, wherein at the load re-identification phase, a central base team (1) repeats the operation of load validation identified (9), determining the arrival of all volume identified in the shipper, being that, at this phase of the process the load has value “2”, while in the load validation phase it had value “1”.

6. “VOLUME IDENTIFICATION SYSTEM” according to claim 1, wherein at the re-dispatch definition phase the central base (1), client (2) e logistic operator (10) define the dispatch date.

7. “VOLUME IDENTIFICATION SYSTEM” according to claim 1, wherein at the re-dispatch phase, in the central base (1), the load volumes are carried or dispatched (14) up the logistic operator (10) that will perform the re-dispatch to the respective clients of client (11).

8. “VOLUME IDENTIFICATION SYSTEM” according to claim 1, wherein the present system foresees the products identification and collection operation (12) performed by the field team (4) and the shipment (13) of the products, by the field team (4), to the central base (1).
